(19) United States
(12) Patent Application Publication
(10) Pub. No.: US 2025/0199805 A1
(43) Pub. Date: Jun. 19, 2025

(54) UPDATING AND DEBUGGING APPLICATION PROGRAM

(71) Applicant: Tencent Technology (Shenzhen) Company Limited, Shenzhen (CN)

(72) Inventors: Chen ZHANG, Shenzhen (CN); Canhui HUANG, Shenzhen (CN)

(73) Assignee: Tencent Technology (Shenzhen) Company Limited, Shenzhen, GD (CN)

(21) Appl. No.: 19/071,596

(22) Filed: Mar. 5, 2025

Related U.S. Application Data
(63) Continuation of application No. PCT/CN2023/130199, filed on Nov. 7, 2023.

(30) Foreign Application Priority Data
Jan. 18, 2023 (CN) 202310096636.X

(51) Int. Cl. G06F 8/77; G06F 8/65; H04L 9/40

(52) U.S. Cl. CPC G06F 8/77; G06F 8/65; H04L 63/0428

(57) ABSTRACT

In a method for updating and debugging an application program performed by a developer tool, a modified portion of a complete code of a first application program is compiled to obtain a first compilation result. An updated code package of the first application program is generated based on the first compilation result and a stored second compilation result. The stored second compilation result corresponds to unmodified portions of the complete code. The updated code package is transmitted to a multi-platform framework. The multi-platform framework is configured to convert the updated code package into a second application program. The second application program and the first application program are configured to operate in different runtime environments.

### RELATED APPLICATIONS

The present application is a continuation of International Application No. PCT/CN2023/130199, filed on Nov. 7, 2023, which claims priority to Chinese Patent Application No. 202310096636.X, filed on Jan. 18, 2023. The entire disclosures of the prior application are hereby incorporated by reference.

### FIELD OF THE TECHNOLOGY

This application relates to the field of computer technologies, including a method for updating and debugging an application program.

### BACKGROUND OF THE DISCLOSURE

With the development of Internet technologies, when developing an application program, a developer continuously updates and debugs code of the application program to find code of the application program that can best meet requirements.

In the related art, for updating and debugging of the application program, code of an updated application program is usually compiled, and a compiled code package is transmitted to a multi-platform framework for running. The multi-platform framework supports development of a set of code that is compiled to run on a plurality of application terminals. In the related art, debugging efficiency of the application program is low.

### SUMMARY

Aspects of this disclosure provide methods and apparatuses for updating and debugging an application program. Examples of technical solutions of this disclosure may be implemented as follows:

An aspect of this disclosure provides a method for updating and debugging an application program, performed by a developer tool. A modified portion of a complete code of a first application program is compiled to obtain a first compilation result. An updated code package of the first application program is generated based on the first compilation result and a stored second compilation result. The stored second compilation result corresponds to unmodified portions of the complete code. The updated code package is transmitted to a multi-platform framework. The multi-platform framework is configured to convert the updated code package into a second application program. The second application program and the first application program are configured to operate in different runtime environments.

An aspect of this disclosure provides a method for updating and debugging an application program, performed by a multi-platform framework. An updated code package of a first application program is received from a developer tool. The updated code package includes a first compilation result of a modified portion of a complete code of the first application program and a stored second compilation result of unmodified portions of the complete code. The first application program is converted into a second application program based on the updated code package. The second application program and the first application program are configured to operate in different running environments.

An aspect of this disclosure provides an apparatus. The apparatus includes processing circuitry configured to compile a modified portion of a complete code of a first application program to obtain a first compilation result. The processing circuitry is configured to generate an updated code package of the first application program based on the first compilation result and a stored second compilation result. The stored second compilation result corresponds to unmodified portions of the complete code. The processing circuitry is configured to transmit the updated code package to a multi-platform framework. The multi-platform framework is configured to convert the updated code package into a second application program. The second application program and the first application program are configured to operate in different runtime environments.

The technical solutions provided in this disclosure can include the following beneficial effects:

Since development and debugging of an application program is a long-term and iterative process, unlike a manner in the related art that complete code of an application program on which a change occurs is compiled, in the technical solutions provided in the aspects of this disclosure, the complete code of the application program that is updated each time is not compiled, only a part in which the code is updated is compiled instead, and a compilation result for unchanged code portions is directly obtained from a cache. Considering that a quantity of code of the application program is likely to be very large, however, each time development and debugging are performed, only a few lines of code are changed, or even just a few numbers in the code are changed. Therefore, in the technical solutions provided in the aspects of this disclosure, by compiling updated code, a compilation speed of the code of the application program during development and debugging can be increased to a greater degree, and development and debugging efficiency of the application program can be improved.

In addition, in the technical solutions provided in the aspects of this disclosure, code of a first application program written in a developer tool is converted into code of a second application program by using a multi-platform framework for running, where the first application program is different from the second application program. Therefore, according to the technical solutions provided in the aspects of this disclosure, the code of the second application program is further run by writing the code of the first application program, that is, the second application program is developed and debugged by adjusting the code of the first application program. Therefore, an application scenario of updating and debugging the application program is provided, and development channels of different applications are enriched.

### BRIEF DESCRIPTION OF THE DRAWINGS

FIG. 1 is a schematic diagram of a solution implementation environment according to an aspect of this disclosure.

FIG. 2 is an interaction flowchart of a method for updating and debugging an application program according to an aspect of this disclosure.

FIG. 3 is a flowchart of a method for updating and debugging an application program according to an aspect of this disclosure.

FIG. 4 is a flowchart of a method for updating and debugging an application program according to another aspect of this disclosure.

FIG. 5 is a flowchart of a method for updating and debugging an application program according to another aspect of this disclosure.

FIG. 6 is a flowchart of a method for updating and debugging an application program according to another aspect of this disclosure.

FIG. 7 is a block diagram of a method for updating and debugging an application program according to an aspect of this disclosure.

FIG. 8 is a schematic diagram of a running result and subprogram code of a mobile application program according to an aspect of this disclosure.

FIG. 9 is a block diagram of an apparatus for updating and debugging an application program according to an aspect of this disclosure.

FIG. 10 is a block diagram of an apparatus for updating and debugging an application program according to another aspect of this disclosure.

FIG. 11 is a block diagram of an apparatus for updating and debugging an application program according to another aspect of this disclosure.

FIG. 12 is a block diagram of an apparatus for updating and debugging an application program according to another aspect of this disclosure.

FIG. 13 is a structural block diagram of a computer device according to an aspect of this disclosure.

### DETAILED DESCRIPTION

Before technical solutions of this disclosure are described, some terms involved in this disclosure are first explained and described. Descriptions of terms in this disclosure are provided as examples only and are not intended to limit the scope of the disclosure.

Integrated development environment (IDE): IDE is a type of application software that assists in developing a computer program. In aspects of this disclosure, the IDE is a developer tool.

Runtime: Runtime describes software or instructions, especially instructions that are not explicitly written but are crucial to normal running of the program, executed when a program runs. In the aspects of this disclosure, a subprogram runtime SDK may refer to an environment and a library on which the subprogram runtime depends.

Application programming interfaces (APIs): APIs are some predefined functions, and an objective thereof is to provide a capability for an application program and a developer to access a set of routines based on specific software or hardware without accessing source code or understanding details of an internal working mechanism.

Sub-packaging: In some cases, a developer needs to divide code of an application program into different subpackages and packages the code into different subpackages during construction, and a user loads the code during use based on requirements.

FIG. 1 is a schematic diagram of a computer system according to an aspect of this disclosure. The computer system may include: a terminal device 10 and a server 20. The terminal device 10 and the server 20 may communicate with each other through a network. The network may be a wired network, or may be a wireless network.

The terminal device 10 includes, but is not limited to, an electronic device such as a mobile phone, a tablet computer, a smart voice interaction device, a game console, a wearable device, a multimedia playback device, a personal computer (PC), an in-vehicle terminal, or a smart home appliance. A client of a target application program may be installed in the terminal device 10.

In this aspect of this disclosure, the foregoing target application program may be any application program that can update and debug a first application program. Typically, the first application program is a subprogram. In some aspects, the subprogram is an applet, and the target application program is a developer tool 101 that can update and debug code of a subprogram. The developer tool 101 updates and debugs the code of the subprogram, so that the subprogram is converted into a mobile application program that can run on the terminal device such as a mobile phone. In addition to the developer tool 101, other types of application programs may also be configured to update and debug code of the first application program, for example, another integrated development environment running on a computer device for development or debugging. Definitely, the updated and debugged first application program may be a music-type application program, a social-type application program, a browser-type application program, a virtual reality (VR)-type application program, an augmented reality (AR)-type application program, or the like. This is not limited in the aspects of this disclosure. Different first application programs correspond to different code of the first application program. Correspondingly, code updated and debugged by the target application program is also different. This is not limited in the aspects of this disclosure. In some aspects, the terminal device 10 runs the client of the foregoing target application program.

In this aspect of this disclosure, the terminal device 10 includes a first terminal device and a second terminal device. The first terminal device is configured to implement a method for updating and debugging an application program on a developer tool side, and the second terminal device is configured to implement a method for updating and debugging an application program on a multi-platform framework side. In this aspect of this disclosure, the first terminal device and the second terminal device are a same terminal device. In some aspects, the first terminal device and the second terminal device are different terminal devices. With reference to FIG. 1, the developer tool 101 runs in the first terminal device, and the method for updating and debugging an application program on the developer tool side is performed through the developer tool 101 in the first terminal device. A multi-platform framework 102 runs in the second terminal device, and the foregoing method for updating and debugging an application program on the multi-platform framework side is performed through the multi-platform framework 102 in the second terminal device.

The server 20 is configured to provide a background service for the client of the target application program in the terminal device 10. For example, the server 20 may be an independent physical server, or may be a server cluster including a plurality of physical servers or a distributed system, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform, but is not limited thereto. In this aspect of this disclosure, the server 20 includes a first server and a second server. The first server is configured to implement the foregoing method for updating and debugging an application program on the developer tool side, and the second server is configured to implement the foregoing method for updating and debugging an application program on the multi-platform framework side. In this aspect of this disclosure, the first server and the second server are a same server. In some aspects, the first server and the second server are different servers. In this aspect of this disclosure, the first server provides a background service of the developer tool, and the foregoing method for updating and debugging an application program on the developer tool side is performed through the first server. In some aspects, the second server provides a background service of the multi-platform framework, and the foregoing method for updating and debugging an application program on the multi-platform framework side is performed through the second server.

In the method provided in the aspects of this disclosure, operations may be performed by a computer device. The computer device may be any electronic device having data storage and processing capabilities. For example, the computer device may be the server 20 in FIG. 1, may be the terminal device 10 in FIG. 1, or may be another device other than the terminal device 10 and the server 20. In this aspect of this disclosure, the computer device may alternatively be a first computer device or a second computer device. In this aspect of this disclosure, the first computer device is at least one of the foregoing first terminal device or the foregoing first server. In some aspects, the second computer device is at least one of the foregoing second terminal device or the foregoing second server.

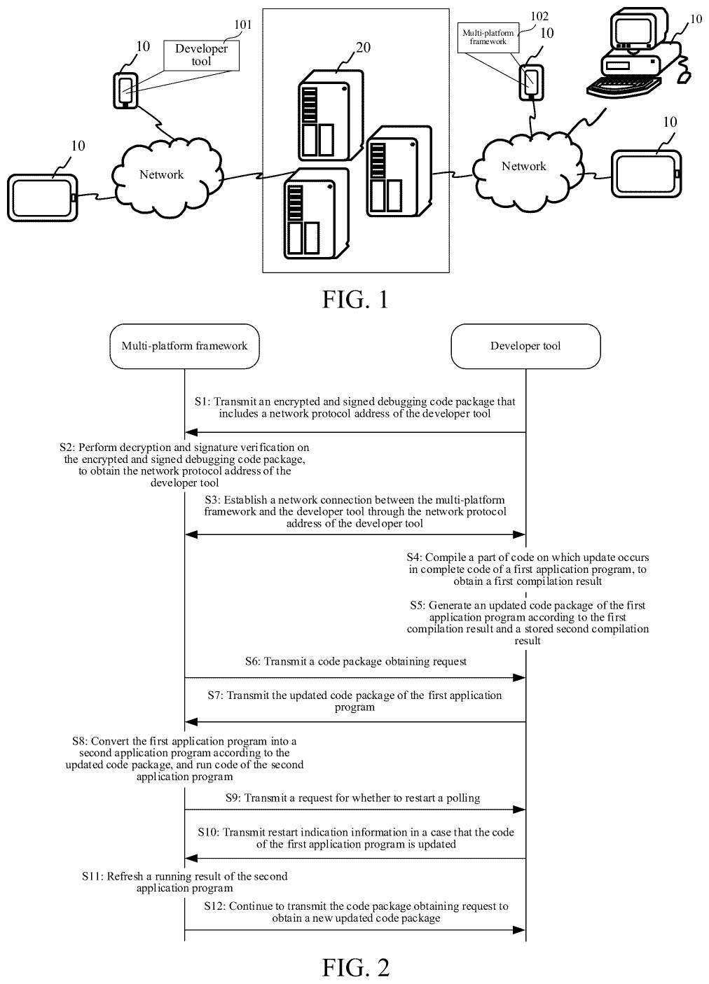

FIG. 2 is a schematic diagram of a solution application scenario of a method for updating and debugging an application program according to an aspect of this disclosure.

Operation S1: A developer tool transmits an encrypted and signed debugging code package that includes a network protocol address of the developer tool to a multi-platform framework. For example, the encrypted and signed debugging code package is transmitted to the multi-platform framework.

Operation S2: The multi-platform framework performs decryption and signature verification on the encrypted and signed debugging code package, to obtain the network protocol address of the developer tool. For example, the encrypted debugging code package is decrypted using a private key of the multi-platform framework to obtain the debugging code package.

Operation S3: Establish a network connection between the multi-platform framework and the developer tool through the network protocol address of the developer tool. For example, the developer tool from the computer device is determined based on the port number to establish the network connection.

Operation S4: Compile a part of code on which update occurs in complete code of a first application program, to obtain a first compilation result. For example, a modified portion of a complete code of a first application program is compiled to obtain a first compilation result.

In this aspect of this disclosure, A in the complete code of the first application program is updated to B, B is the part of code on which update occurs, and B is compiled to obtain the first compilation result.

Operation S5: Generate an updated code package of the first application program according to the first compilation result and a stored second compilation result. For example, an updated code package of the first application program is generated based on the first compilation result and a stored second compilation result.

The second compilation result is a compilation result of a part of code on which no update occurs in the code of the first application program and that is cached in the developer tool.

Operation S6: The multi-platform framework transmits a code package obtaining request to the developer tool.

Operation S7: The developer tool transmits the updated code package of the first application program to the multi-platform framework. For example, the updated code package is transmitted to a multi-platform framework.

Operation S8: The multi-platform framework converts the first application program into a second application program according to the updated code package, and runs code of the second application program. For example, the first application program is converted into a second application program based on the updated code package. The second application program and the first application program are configured to operate in different running environments.

Operation S9: The multi-platform framework transmits a request for whether to restart a polling to the developer tool. For example, a polling request is transmitted to inquire whether to restart the developer tool.

Operation S10: The developer tool transmits restart indication information to the multi-platform framework in a case that the code of the first application program is updated. For example, restart indication information is received from the developer tool.

In a case that the code of the first application program is updated, for example, in a case that B in the code of the first application program is updated to C, the developer tool deletes a compilation result about B, and recompiles the code C to obtain a first compilation result.

Operation S11: The multi-platform framework refreshes a running result of the second application program. For example, running results of the second application program are refreshed.

Operation S12: The multi-platform framework continues to transmit the code package obtaining request to the developer tool to obtain a new updated code package. For example, another updated code package is received from the developer tool.

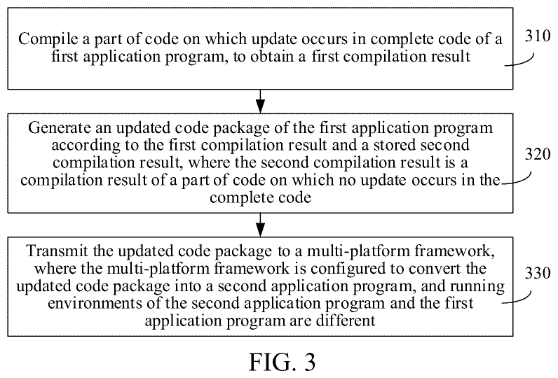

FIG. 3 is a flowchart of a method for updating and debugging an application program according to an aspect of this disclosure. The operations of the method may be performed by the terminal device 10 or the server 20 in the solution implementation environment shown in FIG. 1. In the following method aspects, for ease of description, an example in which the operations are performed by a “computer device” is used for description. The method may include at least one of the following operations (310 to 330).

Operation 310: Compile a part of code on which update occurs in complete code of a first application program, to obtain a first compilation result. For example, a modified portion of a complete code of a first application program is compiled to obtain a first compilation result.

In this aspect of this disclosure, a developer tool compiles the part of code on which update occurs in the complete code of the first application program to obtain the first compilation result. The developer tool is configured to write and compile the code of the first application program. A specific type of the developer tool is not limited in the aspects of this disclosure. In some aspects, the developer tool may alternatively be another integrated development environment for updating and debugging an application program. In some aspects, the developer tool is an “applet developer tool”. In some aspects, the developer tool is a “subprogram developer tool”.

Application program: An application program is a computer program that completes one or more specific jobs, runs in a user mode, can interact with a user, and has a visual user interface. Each application program runs in an independent process, and has independent address space. A dividing line between different application programs is referred to as a process boundary. In the aspects of this disclosure, the application program may refer to a single executable file or a single program. The application program is formed by code. When the application program is updated and debugged, code composition of the application program needs to be updated to implement development and debugging of the application program. In the aspects of this disclosure, the application program may be a native application program (a parent application program), or may be a child application program. This is not limited in the aspects of this disclosure. The native application program is an application program that can directly run in an operating system, and the child application program is an application program that depends on the parent application program to run. The foregoing child application program may be referred to as an applet (that is, one type of the first application program mentioned in the following aspects). The applet cannot run independently, but can be used without downloading and installing. The user may directly open the child application program by scanning a graphic code (such as a quick response code or a bar code) corresponding to the child application program or searching for a name or a related entry of the child application program. The child application program can be conveniently obtained and propagated in the parent application program. The parent application program is an application program configured for carrying the child application program, and provides a running environment for the child application program. In some aspects, the parent application program is a native application program. The parent application program may be a social application program, a dedicated application program that is dedicatedly configured for supporting the child application program, a file management application program, an email application program, a game application program, or the like. The social application program includes an instant messaging application program, a social network service (SNS) application program, a live broadcast application program, or the like.

In this aspect of this disclosure, since a developer needs to continuously update the code of the first application program, the updated part of code is compiled through the developer tool to obtain the first compilation result. In some aspects, through compilation, a process of converting source code (a high-level language) written by the developer through the developer tool into the first application program (a binary language recognizable by the computer device) that can be recognized by the computer device can be implemented.

Operation 320: Generate an updated code package of the first application program according to the first compilation result and a stored second compilation result, where the second compilation result is a compilation result of a part of code on which no update occurs in the complete code. For example, an updated code package of the first application program is generated based on the first compilation result and a stored second compilation result. The stored second compilation result corresponds to unmodified portions of the complete code.

In this aspect of this disclosure, assuming that the code of the first application program is currently updated at a 100^{th} time, a 99^{th} compilation result of the complete code of the first application program has been cached in the developer tool. When the code of the first application program is updated at the 100^{th} time, only the updated part of code is compiled, and directly obtains a compilation result of a non-updated part is directly obtained from the 99^{th} compilation result.

Operation 330: Transmit the updated code package to a multi-platform framework, where the multi-platform framework is configured to convert the updated code package into a second application program, and running environments of the second application program and the first application program are different. For example, the updated code package is transmitted to a multi-platform framework. The multi-platform framework is configured to convert the updated code package into a second application program. The second application program and the first application program are configured to operate in different runtime environments.

Multi-platform framework: A multi-platform framework is a new product and technology form that can convert the code of the first application program into code of the second application program (an iOS system or an Android system). In some aspects, the multi-platform framework is a subprogram multi-platform framework, and code of the subprogram may be converted into code of a mobile application program (the iOS system or the Android system). The multi-platform framework supports multi-platform development, to be specific, supports learning of a set of language at a time and compiles the set of language to a plurality of application sides for running. Common multi-platform frameworks include React Native, Flutter, Ionic, NativeScript, AVM, and the like.

Multi-platform development: Multi-platform development refers to learning a set of language and compiling the set of language to a plurality of application sides for running. Some common application sides, for example, are an Android side (a mobile phone and pad), an iOS side (a mobile phone and pad), a WEB website, a PC side, and an applet platform. The multi-platform development does not necessarily mean writing a set of code that can be run everywhere. A plurality of sets of code may need to be written, but a same set of programming language or development framework is used. For example, when a set of language is compiled for some specific application sides, for example, when the set of language only needs to be compiled for the Android side, the iOS side, and the applet platform, since all of them run on a mobile device, a UI layout can be shared, and API differences of a system or a platform can be compatible through a framework. Therefore, cross-platforms can be implemented, and code needs to be written only once. However, when the WEB website and a PC desktop application run on a computer, a system API and a UI layout are greatly different from those of mobile devices. Therefore, at least two sets of code need to be written to adapt to different system APIs and UI layouts. However, even in this case, applications on a plurality of terminals can be developed by learning only one set of programming language, which greatly reduces a development cycle and costs of the developer.

The second application program is another application program different from the first application program, and the two application programs have a same function but are of different types.

In this aspect of this disclosure, the first application program is a child application program (a subprogram), the second application program is a mobile application program (Application program) or a native application program, and the first application program and the second application program have the same function.

The first application program and the second application program mentioned in the aspects of this disclosure refer to two different types of application programs. However, although the two application programs have the same function, specific effects displayed to the user on the mobile phone are different. In this aspect of this disclosure, since the applet (the first application program) and the mobile application program (the second application program) both run on the mobile device, the UI layout may be shared, the API difference between the operating system and the applet platform may be compatible through the multi-platform framework, and “conversion” refers to compatibility with the API difference between the operating system and the applet platform.

In this aspect of this disclosure, an example in which the computer device is a mobile phone is used. Since the mobile phone corresponds to two systems: iOS and Android, a same application program is to adaptively have different code content under different systems. Using an example in which the application program is a mobile application “application program A”, code corresponding to the “application program A” on the mobile phone of the Android system is different from code corresponding to the “application program A” on the mobile phone of the iOS system.

In this aspect of this disclosure, the Android system and the iOS system each have a corresponding simulator configured to simulate a running result of code of the application program on the mobile phone. A simulator Xcode of the iOS system is used as an example. The simulator may run on any computer device, and after code of the mobile application program is obtained, the simulator may be configured to present a running result of the mobile application program on the mobile phone. The mobile application program cannot directly run on another terminal device except the mobile phone. Therefore, by installing the simulator, the code of the mobile application program runs on the computer device such as a computer. In other words, the mobile application program can be quickly updated and debugged. In some other aspects of this disclosure, the simulator corresponding to the Android system is Android Studio.

In this aspect of this disclosure, after the code of the first application program is converted into the code of the second application program through the multi-platform framework, the second application program runs through the simulator. In this aspect of this disclosure, the first application program is a subprogram, and the second application program is a mobile application program. In this aspect of this disclosure, the developer writes code of the subprogram in the IDE, then imports a compiled code package of the subprogram into a mobile application project, and transmits the compiled code package to the multi-platform framework. The multi-platform framework converts the compiled code package of the subprogram into code of the mobile application program of the Android system (or the iOS system), and runs the code of the mobile application program through the simulator Android Studio of the Android system (or the simulator Xcode of the iOS system), to obtain, on the computer device, a running result of the mobile application program corresponding to the subprogram on the terminal device of the Android system (or the iOS system), so that the developer can perceive accuracy of the code in time and update the code of the subprogram in time, thereby achieving an objective of updating and debugging.

In the technical solutions provided in the aspects of this disclosure, since development and debugging of an application program is a long-term and iterative process, unlike a manner in the related art that complete code of an application program on which a change occurs is compiled, in the technical solutions provided in the aspects of this disclosure, the complete code of the application program that is updated each time is not compiled, only a part in which the code is updated is compiled instead, and a compilation result of a part in which no update occurs is directly obtained from a cache. Considering that a quantity of code of the application program is likely to be very large, however, each time development and debugging are performed, only a few lines of code are changed, or even just a few numbers in the code are changed. Therefore, in the technical solutions provided in the aspects of this disclosure, by compiling updated code, a compilation speed of the code of the application program during development and debugging can be increased to a greater degree, and development and debugging efficiency of the application program can be improved.

In addition, in the technical solutions provided in the aspects of this disclosure, code of a first application program written in a developer tool is converted into code of a second application program by using a multi-platform framework for running, where the first application program is different from the second application program. Therefore, according to the technical solutions provided in the aspects of this disclosure, the code of the second application program is further run by writing the code of the first application program, that is, the second application program is developed and debugged by adjusting the code of the first application program. Therefore, an application scenario of updating and debugging the application program is provided, and development channels of different applications are enriched.

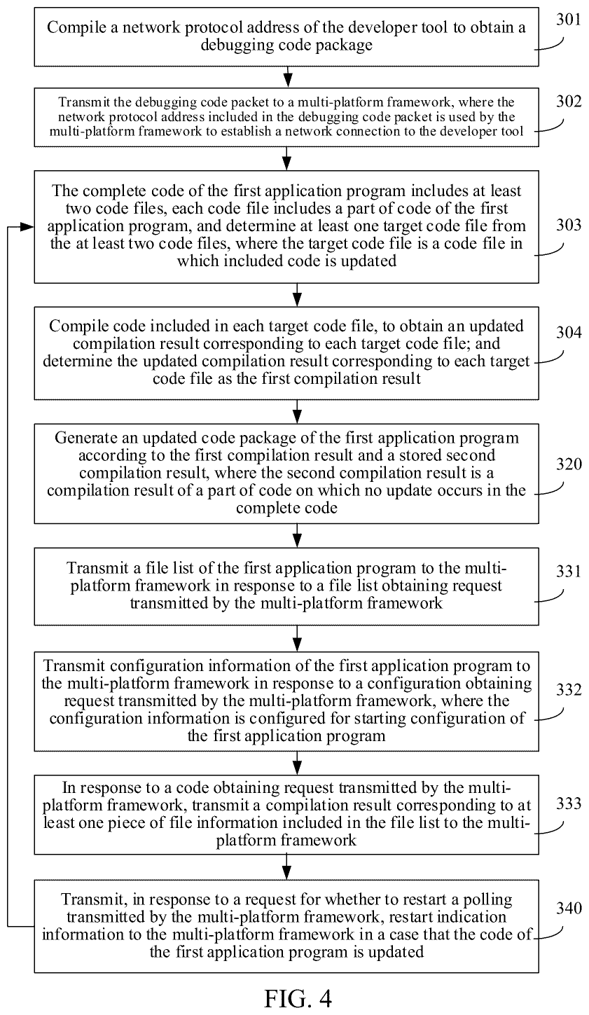

FIG. 4 is a flowchart of a method for updating and debugging an application program according to another aspect of this disclosure. The operations of the method may be performed by the terminal device 10 or the server 20 in the solution implementation environment shown in FIG. 1. In the following method aspects, for ease of description, an example in which the operations are performed by a “computer device” is used for description. The method may include at least one of the following operations (301 to 340):

Operation 301: Compile a network protocol address of a developer tool to obtain a debugging code package. For example, a network protocol address of the developer tool is compiled to obtain a debugging code package.

In this aspect of this disclosure, the network protocol address includes an IP address and a port number. In this aspect of this disclosure, the developer tool and a multi-platform framework are run on a same computer device, and the multi-platform framework can establish a network connection to the developer tool through the IP address and the port number of the developer tool.

In some other aspects of this disclosure, a local server corresponding to the developer tool is configured in the developer tool. When learning of the network protocol address, the multi-platform framework can establish the network connection through the network protocol address and the local server corresponding to the developer tool. Definitely, since the local server corresponding to the developer tool is configured by the developer tool, it may alternatively be considered that the multi-platform framework establishes the network connection to the developer tool. In some other aspects of this disclosure, after the network connection is established, the developer tool may implement information interaction with the multi-platform framework through the local server corresponding to the developer tool, that is, implement information interaction between the developer tool and the multi-platform framework.

Operation 302: Transmit the debugging code package to the multi-platform framework, where the network protocol address included in the debugging code package is used by the multi-platform framework to establish the network connection to the developer tool. For example, the debugging code package is transmitted to the multi-platform framework. The debugging code package includes the network protocol address for establishing a network connection to the developer tool.

In this aspect of this disclosure, for reliability and confidentiality, the debugging code package is encrypted and signed. Definitely, in addition to an encryption and signature manner in the following aspects, other manners such as a message digest, a digital certificate, and a key may further be used. This is not limited in this disclosure. In this aspect of this disclosure, operation 302 includes at least one of operation 302-a to operation 302-c (not shown in the figure).

Operation 302-a: Encrypt the debugging code package by using a public key of the multi-platform framework, to obtain an encrypted debugging code package. For example, the debugging code package is encrypted using a public key of the multi-platform framework to obtain an encrypted debugging code package.

In this aspect of this disclosure, the developer tool encrypts the debugging code package by using the public key of the multi-platform framework, to obtain the encrypted debugging code package. Correspondingly, the multi-platform framework may decrypt the debugging code package by using a private key of the multi-platform framework, to verify that the debugging code package is transmitted to the multi-platform framework, to ensure security of information transmission.

Operation 302-b: Sign the encrypted debugging code package by using a private key of the developer tool, to obtain an encrypted and signed debugging code package. For example, the encrypted debugging code package is signed using a private key of the developer tool to obtain an encrypted and signed debugging code package.

In this aspect of this disclosure, the developer tool encrypts the debugging code package by using the private key of the developer tool, to obtain the encrypted debugging code package. Correspondingly, the multi-platform framework may decrypt the debugging code package by using a public key of the developer tool, to verify that the debugging code package comes from the developer tool, to ensure reliability of an information source.

Operation 302-c: Transmit the encrypted and signed debugging code package to the multi-platform framework. For example, the encrypted and signed debugging code package is transmitted to the multi-platform framework.

In this aspect of this disclosure, the developer tool transmits the encrypted and signed debugging code package to the multi-platform framework. In some other aspects of this disclosure, the debugging code package (the encrypted and signed debugging code package) is provided to the multi-platform framework in the form of a file, and the developer is not necessarily required to directly transmit the debugging code package to the multi-platform framework. A specific manner in which the developer tool transmits the debugging code package to the multi-platform framework is not limited. In some aspects, the debugging code package is transmitted to the multi-platform framework through a specific transmission channel. In some aspects, the debugging code package is provided to the multi-platform framework in the form of copy and paste.

Operation 303: The complete code of the first application program includes at least two code files, each code file includes a part of code of the first application program, and determine at least one target code file from the at least two code files, where the target code file is a code file in which included code is updated. For example, the complete code of the first application program includes at least two code files. Each code file includes a portion of the complete code. In an example, at least one target code file from the at least two code files containing the modified portion of the complete code is identified.

In this aspect of this disclosure, the complete code of the first application program is divided by using a file as a granularity. Using an example in which the complete code of the first application program includes 100 lines, one file is set to include 10 lines of code, and the 100 lines of the complete code of the first application program may be divided into 10 code files.

In some other aspects of this disclosure, the complete code of the first application program is divided by using a function of the code as a granularity. For example, the complete code of the first application program includes a function a, a function b, and a function c. A code part corresponding to the function a is divided into a code file 1, a code part corresponding to the function b is divided into a code file 2, and a code part corresponding to the function c is divided into a code file 3.

In this aspect of this disclosure, coarseness or fineness of the granularity is not limited, and a quantity of code included in one code file is not limited. In some aspects, the complete code of the first application program includes at least two code files, and each code file includes a part of code of the first application program. The target code file is a code file in which included code is updated. In other words, a code file of the changed code part is determined from a plurality of code files corresponding to the complete code of the first application program, and is used as the target code file. A quantity of target code files is not limited in the aspects of this disclosure. In some aspects, the quantity of target code files is at least one.

Definitely, if the granularity is fine, the quantity of code included in one code file is small, and when the code of the first application program is updated, less code needs to be compiled. Therefore, a compilation speed of the updated code part is improved.

Conversely, if the granularity is coarse, the quantity of code included in one code file is large, which facilitates determining a code file in which the updated code part is located, which also reduces early processing overheads of the developer tool, and reduces processing pressure on the computer.

Operation 304: Compile code included in each target code file, to obtain an updated compilation result corresponding to each target code file; and determine the updated compilation result corresponding to each target code file as the first compilation result. For example, the at least one target code file is compiled to obtain the first compilation result.

Operation 320: Generate an updated code package of the first application program according to the first compilation result and a stored second compilation result, where the second compilation result is a compilation result of a part of code on which no update occurs in the complete code. For example, the updated code package of the first application program is generated based on the first compilation result and the stored second compilation result.

In this aspect of this disclosure, operation 320 includes operation 321 and operation 322 (not shown in the figure).

Operation 321: Obtain, from stored compilation results respectively corresponding to the code files, a compilation result corresponding to a remaining code file other than the target code file in the at least two code files, to obtain the second compilation result. For example, the stored second compilation result is obtained based on stored compilation results of non-target code files.

In this aspect of this disclosure, an example in which a quantity of code files is 10 is used. It is assumed that the code file 1 and the code file 2 are target code files, that is, code files of the updated code part. The code file 1 and the code file 2 are compiled to obtain updated compilation results respectively corresponding to the code file 1 and the code file 2. A sum of the updated compilation results respectively corresponding to the code file 1 and the code file 2 is used as the first compilation result. In some aspects, in the 10 code files, compilation results of code files other than the code file 1 and the code file 2 are obtained from a cache to obtain the second compilation result.

In this aspect of this disclosure, the complete code of the first application program includes at least two code files of different granularities. In this aspect of this disclosure, the code of the first application program is divided according to specific code content. In some aspects, the complete code of the first application program is divided into frequently updated code and infrequently updated code. In some aspects, the frequently updated code refers to code whose frequency of being updated in the code of the first application program exceeds a first threshold. For example, if a fifth line of code in the code of the first application program is updated 50 times out of 100 times of updating and debugging, it is considered that the fifth line of code is the frequently updated code. In some aspects, the infrequently updated code refers to code whose frequency of being updated in the code of the first application program is less than a second threshold. For example, if an eighth line of code in the code of the first application program is updated only 3 times out of 100 times of updating and debugging, it is considered that the eighth line of code is the infrequently updated code.

In some aspects, the frequently updated code is divided according to a first granularity to obtain at least one code file. In some aspects, the infrequently updated code is divided according to a second granularity to obtain at least one code file. In some aspects, the first granularity is finer than the second granularity. In some aspects, the first granularity is one code file for every 3 lines of code, and the second granularity is one code file for every 10 lines of code.

In this aspect of this disclosure, the code of the first application program is divided into the frequently updated code and the infrequently updated code, the frequently updated code is divided into code files by using a fine granularity, and the infrequently updated code is divided into code files by using a coarse granularity. Based on the foregoing code division manner, the quantity of code in the determined target code file can be small, thereby minimizing code content that needs to be compiled.

Operation 322: Generate an updated code package of the first application program according to the first compilation result and the second compilation result. For example, the updated code package of the first application program is generated based on the first compilation result and the stored second compilation result.

In this aspect of this disclosure, the updated code package of the first application program is determined by combining the first compilation result and the second compilation result. In this aspect of this disclosure, when the updated code package is transmitted to the multi-platform framework, the developer tool first transmits the second compilation result. In a process of transmitting the second compilation result, the target code file is synchronously compiled, so that code transmission and code compilation can be performed synchronously, helping shorten time for transmitting the updated code package to the multi-platform framework, and improve updating and debugging efficiency.

In this aspect of this disclosure, after operation 322, at least one of operation 323 or operation 324 (not shown in the figure) is further included.

Operation 323: Delete a stored compilation result corresponding to each target code file. For example, stored compilation results corresponding to the at least one target code file are deleted.

In this aspect of this disclosure, since the target code file is a code file that needs to be recompiled, the stored compilation result corresponding to each target code file is deleted. Therefore, it is beneficial to reduce storage pressure in the developer tool, and when a remaining storage amount is sufficient, a processing speed can be fully increased.

Operation 324: Store the updated compilation result corresponding to each target code file. For example, the updated compilation result corresponding to the at least one target code file is stored.

In this aspect of this disclosure, after the target code file is recompiled, the updated compilation result corresponding to the recompiled target code file needs to be cached.

Operation 331: Transmit a file list of the first application program to the multi-platform framework in response to a file list obtaining request transmitted by the multi-platform framework. For example, a file list of the first application program is transmitted to the multi-platform framework when a file list obtaining request is transmitted by the multi-platform framework. The file list records file information for each code file of the first application program.

In this aspect of this disclosure, since the code of the first application program is divided by using a file as a granularity, the multi-platform framework first transmits a request to obtain the file list corresponding to the code of the first application program to the developer tool. The file list does not include a specific compilation result, but only includes a name of the file list.

Operation 332: Transmit configuration information of the first application program to the multi-platform framework in response to a configuration obtaining request transmitted by the multi-platform framework, where the configuration information is configured for starting configuration of the first application program. For example, configuration information of the first application program is transmitted to the multi-platform framework when a configuration obtaining request is transmitted by the multi-platform framework. A configuration of the first application program is initiated based on the configuration information.

In this aspect of this disclosure, the configuration information is a configuration parameter. In some aspects, the developer tool presets the configuration information of the first application program.

Operation 333: In response to a code obtaining request transmitted by the multi-platform framework, transmit a compilation result corresponding to at least one piece of file information included in the file list to the multi-platform framework. For example, when a code obtaining request is transmitted by the multi-platform framework, at least one compilation result corresponding to at least one code file listed in the file list is transmitted.

In this aspect of this disclosure, when obtaining the specific code content, the multi-platform framework may obtain compilation results corresponding to all file information included in the file list at a time. Definitely, the compilation result corresponding to the at least one piece of file information included in the file list may alternatively be obtained in batches. If the multi-platform framework can obtain all compilation results at a time, it is considered that a sub-packaging function is not enabled when the developer tool transmits the compilation result. If the multi-platform framework can obtain the compilation results in batches, it is considered that the sub-packaging function is enabled when the developer tool transmits the compilation result.

In some other aspects of this disclosure, in response to the file list obtaining request transmitted by the multi-platform framework, indication information indicating whether to enable the sub-packaging function is further transmitted to the multi-platform framework. In some aspects, first indication information indicates that the sub-packaging function is enabled, and second indication information indicates that the sub-packaging function is not enabled.

In this aspect of this disclosure, operation 333 includes operation 333-a to operation 333-d (not shown in the figure).

In some other aspects of this disclosure, the developer tool packages the compilation result according to different functions of the first application program. In some aspects, one subpackage may include a plurality of file lists.

Operation 333-a: In a case that sub-packaging function is enabled, determine file information required for maintaining running of the first application program in the compilation result corresponding to the at least one piece of file information included in the file list as a main package. For example, when sub-packaging is enabled, a first portion of the complete code required for maintaining operation of the first application program is determined as a main package.

Operation 333-b: Determine file information corresponding to different functions of the first application program in the compilation result corresponding to the at least one piece of file information included in the file list as at least one subpackage, where the at least one subpackage corresponds to function description information, and the function description information is configured for describing a function of the first application program corresponding to the subpackage. For example, a second portion of the complete code corresponding to different functions of the first application program is determined as at least one subpackage. Each of the at least one subpackage corresponds to function description information. The function description information describes a function of the first application program corresponds to the subpackage.

In this aspect of this disclosure, the code file of the first application program is divided according to different function implementations of the first application program, to obtain a plurality of subpackages. In addition, the function description information of the subpackage is determined according to a specifically implemented function. In some aspects, if the function of the first application program is “support to enable a split-screen mode”, correspondingly, the function description information of the subpackage may be “split-screen mode”. Definitely, a type of the specific description information is not limited in this disclosure, and may be in the form of a number or a text. In some aspects, if the function description information is determined in the form of a number, a correspondence between the number and a specific function may be preset in the developer tool and the multi-platform framework (for example, the correspondence is preset in the form of a table), so that the developer tool can learn of different functions corresponding to different subpackages without transmitting the specific function description information to the multi-platform framework but only the number, which is beneficial to reduce pressure of data transmission.

Operation 333-c: Transmit a compilation result of file information corresponding to the main package to the multi-platform framework. For example, a compilation result of the file information corresponding to the main package is transmitted.

Operation 333-d: Transmit, in response to a target subpackage obtaining request transmitted by the multi-platform framework, a compilation result of file information corresponding to a target subpackage to the multi-platform framework, where the target subpackage is one of the at least one subpackage. For example, in response to a subpackage obtaining request, a compilation result of the file information corresponding to a requested subpackage is transmitted.

In some aspects, the multi-platform framework determines the target subpackage from the plurality of subpackages according to the configuration file and the function description information, and transmits the target subpackage obtaining request to the developer tool.

In some other aspects of this disclosure, the multi-platform framework obtains the compilation result of the code file corresponding to the subpackage from the developer tool at a time or in batches. In this aspect of this disclosure, the subpackage that the multi-platform framework needs to obtain from the developer tool is determined according to the function description information. In some aspects, the multi-platform framework needs to obtain subpackages 1 to 3 from the developer tool. In some aspects, all subpackages that need to be obtained are transmitted at a time through a communication tube. In some aspects, in a case that a quantity of subpackages is large, transmission is performed through a plurality of communication tubes. For example, the foregoing three subpackages are transmitted in parallel through three communication tubes, to improve data transmission efficiency. In some aspects, other communication tubes may be established through Bluetooth or the like. This is not limited in this disclosure.

Operation 340: Transmit, in response to a request for whether to restart a polling transmitted by the multi-platform framework, restart indication information to the multi-platform framework in a case that the code of the first application program is updated. For example, when the polling request is received, restart indication information is transmitted to the multi-platform framework when the modified portion of the complete code of the first application program is modified to trigger recompilation.

In this aspect of this disclosure, the restart indication information includes a specific field or identifier. When receiving the specific field or identifier, the multi-platform framework considers that the developer tool indicates that restart is required.

In this aspect of this disclosure, the multi-platform framework transmits the request for whether to restart a polling to the developer tool. In some aspects, an interval for transmitting the request for whether to restart a polling is less than a threshold. In some aspects, the interval for transmitting the request for whether to restart a polling is 2 s.

In this aspect of this disclosure, when the code of the first application program is updated, automatic compilation may be triggered. In this case, it is considered that the developer tool needs to instruct the multi-platform framework to restart. Therefore, the restart indication information is transmitted to the multi-platform framework. In some other aspects of this disclosure, the developer tool transmits the restart indication information to the multi-Docket platform framework in response to a specific restart operation performed by the developer on the developer tool. In some aspects, the specific restart operation is an operation such as clicking, double-clicking, or sliding on a compilation button on the developer tool. A specific operation type is not limited in this disclosure.

In this aspect of this disclosure, after operation 340, operation 303 continues to be performed.

In some aspects, after the developer tool transmits the restart indication information, the developer tool continues to perform the operation of compiling a part of code on which update occurs in complete code of a first application program to obtain a first compilation result, that is, recompiling newly changed code. In some other aspects of this disclosure, even if the developer tool transmits the restart indication information, but the code of the first application program does not change, the compilation result of the code of the first application program is directly obtained from the cache and transmitted to the multi-platform framework.

In this aspect of this disclosure, the debugging code package only needs to be transmitted once, and the network connection also only needs to be established once. Unless the network connection is disconnected, the multi-platform framework does not need to perform decryption and signature verification on the debugging code package. In a subsequent process of code transmission, there is no need to perform decryption and signature verification again to verify accuracy of establishing a connection to the developer tool. After the decryption and signature verification is performed once, it is considered that a trusted connection is established between the multi-platform framework and the developer tool, and transmission is directly performed through the communication tube during subsequent code transmission. Therefore, it is beneficial to reduce a data transmission speed, and further improve the updating and debugging efficiency.

In some aspects, in the technical solutions provided in the aspects of this disclosure, the code of the first application program is divided by using a file as a granularity, to obtain a plurality of code files. When the developer updates the code of the first application program by using the developer tool, the target code file is determined from the plurality of code files, and only the target code file is recompiled. It is beneficial to determine a position of changed code. In addition, it is beneficial to reduce a quantity of code that needs to be compiled, thereby improving the updating and debugging efficiency.

In some other aspects, the compilation result of the code file other than the target code file is obtained from the cache, and the updated code package of the first application program is determined in combination with the updated compilation result of the target code file. This helps ensure integrity of the updated code package, and division is performed by using a file as a granularity. While ensuring that an amount of code that needs to be compiled is reduced, it is easier and faster to determine the target code file than determining a position of specific updated code. Therefore, a speed of determining the target code file is also improved, further improving a compilation speed.

In addition, the debugging code package enables the multi-platform framework to establish a network connection to the developer tool, and the multi-platform framework can directly obtain the code from the developer tool through the communication tube. When the network connection is established, the developer tool has ensured accuracy of an address in an encryption and signature manner. Therefore, the developer tool can subsequently directly transmit the code to the multi-platform framework through the communication tube without worrying other risks such as data leakage.

In an example, when requesting the code content from the developer tool, the multi-platform framework may first obtain the file list, then obtain the configuration information, and then obtain the compilation result of the file information in the file list. There are rules for obtaining the code, to reduce the possibility of data transmission errors. In addition, the file list is cached inside the multi-platform framework to further obtain the compilation result. In a case of sub-packaging, the code content is gradually obtained according to a specific requirement, helping avoid obtaining unnecessary code content, improving a running speed of the multi-platform framework for the code, and reducing cached data in the multi-platform framework.

In addition, the request for whether to restart a polling always transmitted by the multi-platform framework to the developer tool enables the multi-platform framework to learn of the restart indication information transmitted by the developer tool in time to restart, thereby improving a reaction speed for next updating and debugging.

In this aspect of this disclosure, the first application program is a subprogram, and the second application program is a mobile application program. This can enrich application scenarios of the application programs to some degree and enrich conversion manners between the application programs.

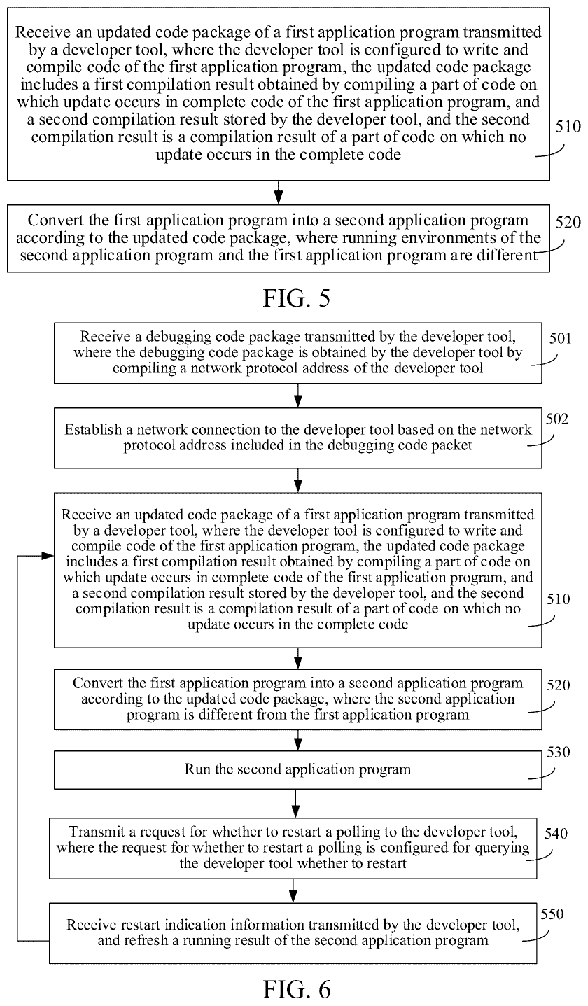

FIG. 5 is a flowchart of a method for updating and debugging an application program according to another aspect of this disclosure. The operations of the method may be performed by the terminal device 10 or the server 20 in the solution implementation environment shown in FIG. 1. In the following method aspects, for ease of description, an example in which the operations are performed by a “computer device” is used for description. The method may include at least one of the following operations (510 and 520):

Operation 510: Receive an updated code package of a first application program transmitted by a developer tool, where the developer tool is configured to write and compile code of the first application program, the updated code package includes a first compilation result obtained by compiling a part of code on which update occurs in complete code of the first application program and a second compilation result stored by the developer tool, and the second compilation result is a compilation result of a part of code on which no update occurs in the complete code. For example, an updated code package of a first application program is received from a developer tool. The updated code package includes a first compilation result of a modified portion of a complete code of the first application program and a stored second compilation result of unmodified portions of the complete code.

Operation 520: Convert the first application program into a second application program according to the updated code package, where running environments of the second application program and the first application program are different. For example, the first application program is converted into a second application program based on the updated code package. The second application program and the first application program are configured to operate in different running environments.

For a specific implementation process, refer to the foregoing aspects. Details are not described herein again.

In the technical solutions provided in the aspects of this disclosure, since development and debugging of an application program is a long-term and iterative process, unlike a manner in the related art that complete code of an application program on which a change occurs is compiled, in the technical solutions provided in the aspects of this disclosure, the complete code of the application program that is updated each time is not compiled, only a part in which the code is updated is compiled instead, and a compilation result of a part in which no update occurs is directly obtained from a cache. Considering that a quantity of code of the application program is likely to be very large, however, each time development and debugging are performed, only a few lines of code are changed, or even just a few numbers in the code are changed. Therefore, in the technical solutions provided in the aspects of this disclosure, by compiling updated code, a compilation speed of the code of the application program during development and debugging can be increased to a greater degree, and development and debugging efficiency of the application program can be improved.

In addition, in the technical solutions provided in the aspects of this disclosure, code of a first application program written in a developer tool is converted into code of a second application program by using a multi-platform framework for running, where the first application program is different from the second application program. Therefore, according to the technical solutions provided in the aspects of this disclosure, the code of the second application program is further run by writing the code of the first application program, that is, the second application program is developed and debugged by adjusting the code of the first application program. Therefore, an application scenario of updating and debugging the application program is provided, and development channels of different applications are enriched.

FIG. 6 is a flowchart of a method for updating and debugging an application program according to another aspect of this disclosure. The operations of the method may be performed by the terminal device 10 or the server 20 in the solution implementation environment shown in FIG. 1. In the following method aspects, for ease of description, an example in which the operations are performed by a “computer device” is used for description. The method may include at least one of the following operations (501 to 550):

Operation 501: Receive a debugging code package transmitted by the developer tool, where the debugging code package is obtained by the developer tool by compiling a network protocol address of the developer tool. For example, a debugging code package is received from the developer tool. The debugging code package includes a network protocol address.

In this aspect of this disclosure, operation 501 includes operation 501-a to operation 501-c (not shown in the figure).

Operation 501-a: Receive an encrypted and signed debugging code package transmitted by the developer tool, where the encrypted and signed debugging code package is obtained after the developer tool encrypts and signs the debugging code package. For example, an encrypted and signed debugging code package is received from the developer tool.

Operation 501-b: Perform signature verification on the encrypted and signed debugging code package by using a public key of the developer tool, to obtain an encrypted debugging code package. For example, the encrypted and signed debugging code package is verified using a public key from the developer tool to obtain an encrypted debugging code package.

Operation 501-c: Decrypt the encrypted debugging code package by using a private key of the multi-platform framework, to obtain the debugging code package. For example, the encrypted debugging code package is decrypted using a private key of the multi-platform framework, to obtain the debugging code package.

Operation 502: Establish a network connection to the developer tool based on the network protocol address included in the debugging code package. For example, a network connection to the developer tool is established based on the network protocol address included in the debugging code package.

In this aspect of this disclosure, the network protocol address includes an Internet Protocol IP address and a port number, and operation 502 includes operation 502-a and operation 502-b (not shown in the figure).

Operation 502-a: Determine, based on the IP address, a computer device in which the developer tool is located. For example, a computer device corresponding to the IP address is determined.

Operation 502-b: Determine the developer tool from the computer device according to the port number, to establish the network connection. For example, the developer tool from the computer device is determined based on the port number to establish the network connection.

In this aspect of this disclosure, the developer tool and the multi-platform framework are run on a same computer device, or may be run on different computer devices.

The multi-platform framework may determine, based on the IP address, the computer device in which the developer tool is located. Further, the multi-platform framework may determine, according to the port number, a position at which the developer tool is determined from the computer device.

Operation 510: Receive an updated code package of a first application program transmitted by a developer tool, where the developer tool is configured to write and compile code of the first application program, the updated code package includes a first compilation result obtained by compiling a part of code on which update occurs in complete code of the first application program, and a second compilation result stored by the developer tool, and the second compilation result is a compilation result of a part of code on which no update occurs in the complete code. For example, an updated code package of a first application program is received from a developer tool. The updated code package includes a first compilation result of a modified portion of a complete code of the first application program and a stored second compilation result of unmodified portions of the complete code.

In this aspect of this disclosure, operation 510 includes operation 511 to operation 516 (not shown in the figure).

Operation 511: Transmit a file list obtaining request to the developer tool, where the file list obtaining request is configured for requesting the developer tool to transmit a file list of the first application program, and the file list records file information of a compilation result of each code file of the first application program.

Operation 512: Receive the file list of the first application program transmitted by the developer tool.

Operation 513: Transmit a configuration obtaining request to the developer tool, where the configuration obtaining request is configured for requesting the developer tool to transmit configuration information of the first application program, and the configuration information is configured for starting configuration of the first application program.

Operation 514: Receive the configuration information of the first application program transmitted by the developer tool.

In this aspect of this disclosure, after obtaining the configuration information, the multi-platform framework starts the first application program.

Operation 515: Transmit a code obtaining request to the developer tool, where the code obtaining request is configured for requesting the developer tool to transmit a compilation result corresponding to at least one piece of file information included in the file list.

Operation 516: Receive the compilation result corresponding to the at least one piece of file information included in the file list transmitted by the developer tool.

In this aspect of this disclosure, the file list corresponds to identification information configured for informing the multi-platform framework of whether to enable the sub-packaging function. In a case that the sub-packaging function is enabled, operation 516 includes operation 516-a to operation 516-d (not shown in the figure).

Operation 516-a: Receive a compilation result of file information corresponding to a main package transmitted by the developer tool, where the main package is file information required for maintaining running of the first application program in the compilation result corresponding to the at least one piece of file information included in the file list.

Operation 516-b: Determine a target subpackage from at least one subpackage according to function description information respectively corresponding to the at least one subpackage.

Operation 516-c: Transmit a target subpackage obtaining request to the developer tool, where the target subpackage obtaining request is configured for requesting the developer tool to transmit a compilation result of file information corresponding to the target subpackage.

Operation 516-d: Receive the compilation result of the file information corresponding to the target subpackage.

Operation 520: Convert the first application program into a second application program according to the updated code package, where the second application program is different from the first application program. For example, the first application program is converted into a second application program based on the updated code package. The second application program and the first application program are configured to operate in different running environments.

Operation 530: Run the second application program.

Operation 540: Transmit a request for whether to restart a polling to the developer tool, where the request for whether to restart a polling is configured for querying the developer tool whether to restart. For example, a polling request inquiring whether to restart the developer tool is transmitted.

Operation 550: Receive restart indication information transmitted by the developer tool, and refresh a running result of the second application program. For example, restart indication information is received from the developer tool.

In this aspect of this disclosure, the multi-platform framework refreshes the running result of the second application program after receiving the restart indication information transmitted by the developer tool. In some aspects, the multi-platform framework clears all buffer results about the second application program after receiving the restart indication information transmitted by the developer tool, so that the multi-platform framework is in a clean state, which is beneficial to run an updated code package received next time, to ensure that the running result is not interfered by other data, and improve accuracy of the running result.

In this aspect of this disclosure, after operation 550, execution continues from operation 510.

In this aspect of this disclosure, the first application program is a subprogram, the second application program is a mobile application program, and the first application program and the second application program have a same function.

In this aspect of this disclosure, after refreshing the running result of the second application program, the multi-platform framework continues to transmit the code obtaining request to the developer tool, to request the developer tool to transmit a new updated code package.

In this aspect of this disclosure, the multi-platform framework no longer obtains the debugging code package from the developer tool. Since the network connection is established, execution only needs to be performed starting from an operation of re-obtaining the file.

For specific descriptions of other operations, refer to the foregoing aspects. Details are not described herein again.

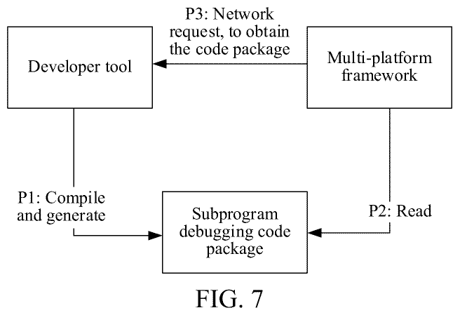

FIG. 7 is a block diagram of a method for updating and debugging an application program according to another aspect of this disclosure. The method may include at least one of the following operations (P1 to P3).

Operation P1: A developer tool compiles and generates a subprogram debugging code package.

The developer may generate the debugging code package in the developer tool, and place the debugging code package into a project of the mobile application program. Then a running result in the mobile application program may be refreshed as long as compilation of the developer tool is clicked after the code is developed in the developer tool. Subsequently, there is no need to continue to generate a subprogram code package a plurality of times, so that the developer can more quickly view an effect of code developed by the developer in the mobile application program displayed by a simulator. In this aspect of this disclosure, the developer tool is run by the terminal device.

When compiling the debugging code package, the developer tool writes a local IP address and a port number enabled by the developer tool into the code package, and does not directly compile the code package, so that compilation time is reduced and short. It takes a long time to normally compile the code package, and the code package needs to be compiled and signed in the background. If there is more code, the compilation time in the background is very long (the time including uploading, compilation, and download). If only the local IP address and the port number need to be compiled, the background compilation is fast.

Operation P2: A multi-platform framework reads the subprogram debugging code package.

When the multi-platform framework is run in the mobile application program, the code package is first read. When it is found that the code package is the debugging code package, a file is not directly read from the code package, but a network connection is established to a local server of the developer tool through the IP address and a port recorded. Since content of the network address is signed by the background, the content of the network address is verified as a trusted IP address, which ensures that the address cannot be tampered with.

In some aspects, when the code package is the debugging code package, the debugging code package carries identification information configured for notifying the multi-platform framework that the code package is the debugging code package. In this aspect of this disclosure, the multi-platform framework is run by the terminal device. In some aspects, the terminal device running the developer tool and the terminal device running the multi-platform framework are a same device or different devices.

Operation P3: The multi-platform framework transmits a network request to the developer tool to request to obtain a code package.

The multi-platform framework requests all information required for the code package, and the developer tool returns corresponding compiled code package content. The multi-platform framework may first request all file lists in the code package, to determine whether the start of the subprogram enables functions such as sub-packaging. The multi-platform framework caches the file list inside the multi-platform framework, and then separately requests configuration of the subprogram for starting. After completion, the code developed by the developer is requested for running of the framework. Subsequently, if a subprogram subpackage is encountered, the code content of the subpackage continues to be requested.

In addition, the developer tool is queried whether the subprogram needs to be restarted. When the subprogram needs to be restarted, the process of the current mobile application program is disabled and refreshed by the multi-platform framework. In this way, after clicking compilation in the developer tool, the developer can trigger refreshing of the mobile application program.

After receiving information indicating that the mobile application program needs to be restarted, the multi-platform framework terminates running of the mobile application program, clears a memory buffer of the mobile application program, and then restarts and starts the mobile application program. The file list is re-requested from the developer tool, thereby completing a refresh operation.

In this aspect of this disclosure, the local server created by the developer tool compiles the subprogram code when receiving the network request initiated by the multi-platform framework. In addition, the compilation result may be cached for next use depending on whether the file is changed. When receiving a request next time, the developer tool (which may also be considered as the local server created by the developer tool) may determine, by using a file as a granularity, whether code is changed, and then selectively compile the code. For code that is not changed, data may be directly obtained from the cache and returned, and the changed code may be recompiled.

When receiving the request for whether to restart a polling from the multi-platform framework, the developer tool may determine whether the current developer clicks a compile button to return “whether restart is required”. The developer tool may also return, according to whether the code of the subprogram changes, whether the code needs to be restarted.

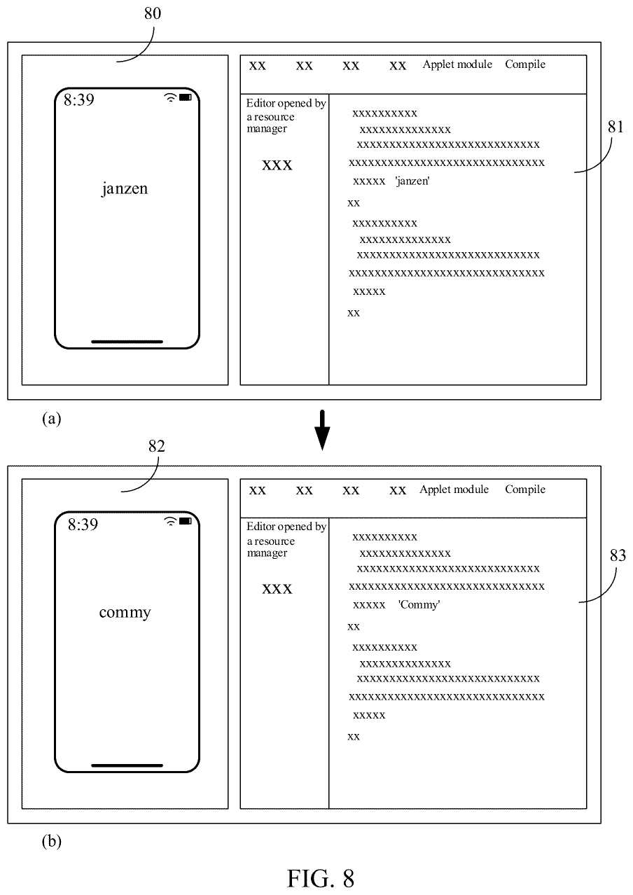

In this aspect of this disclosure, FIG. 8 shows that when the code of the subprogram in the developer tool changes, a running effect of a corresponding mobile application program changes. In part (a) of FIG. 8, a running result 80 of an Xcode simulator for the mobile application program is on the left program, and subprogram code 81 in an applet developer tool is on the right. When the subprogram code 81 is changed to obtain subprogram code 83 in part (b) of FIG. 8, in this case, the code received by the multi-platform framework changes, the code of the corresponding mobile application program changes, and the running result of the Xcode simulator for the mobile application program becomes as shown in 82.

The technical solutions provided in the aspects of this disclosure provide faster compilation efficiency, reduce time of waiting for compilation, and help the developer improve development efficiency.

Apparatus aspects of this disclosure are described below, and may be used to perform the method aspects of this disclosure. For details not disclosed in the apparatus aspects of this disclosure, refer to the method aspects of this disclosure.

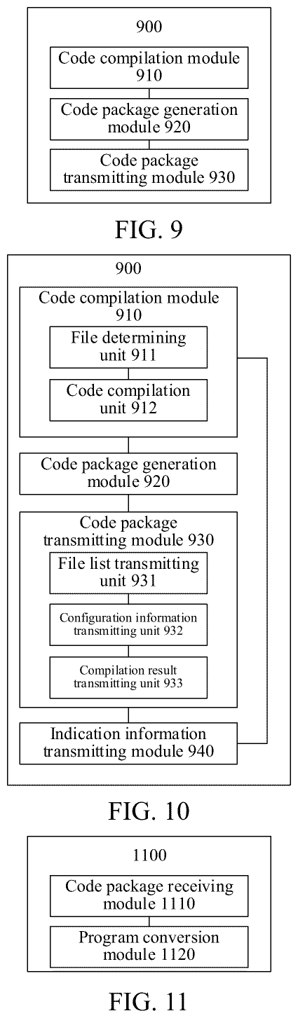

FIG. 9 is a block diagram of an apparatus for updating and debugging an application program according to an aspect of this disclosure. The apparatus has a function of performing the foregoing method aspects, the function may be implemented by hardware or may be implemented by hardware executing corresponding software. The apparatus may be the computer device described above, or may be disposed in the computer device. As shown in FIG. 8, an apparatus 900 may include a code compilation module 910, a code package generation module 920, and a code package transmitting module 930.

The code compilation module 910 is configured to compile a part of code on which update occurs in complete code of a first application program, to obtain a first compilation result.

The code package generation module 920 is configured to generate an updated code package of the first application program according to the first compilation result and a stored second compilation result, the second compilation result being a compilation result of a part of code on which no update occurs in the complete code.

The code package transmitting module 930 is configured to transmit the updated code package to a multi-platform framework, the multi-platform framework being configured to convert the updated code package into a second application program, and running environments of the second application program and the first application program being different.

In this aspect of this disclosure, the complete code of the first application program includes at least two code files, and each code file includes part of code of the first application program.

In this aspect of this disclosure, as shown in FIG. 10, the code compilation module 910 includes a file determining unit 911 and a code compilation unit 912.

The file determining unit 911 is configured to determine at least one target code file from the at least two code files, the target code file is a code file in which included code being updated.

The code compilation unit 912 is configured to compile code included in each target code file, to obtain an updated compilation result corresponding to each target code file; and

the file determining unit 911 is further configured to determine the updated compilation result corresponding to each target code file as the first compilation result.

In this aspect of this disclosure, the code package generation module 920 is configured to obtain, from stored compilation results respectively corresponding to the code files, a compilation result corresponding to a remaining code file other than the target code file in the at least two code files, to obtain the second compilation result.

The code package generation module 920 is further configured to generate an updated code package of the first application program according to the first compilation result and the second compilation result.

In this aspect of this disclosure, the code compilation module 910 is further configured to delete a stored compilation result corresponding to each target code file.

The code compilation module 910 is further configured to store the updated compilation result corresponding to each target code file.

In this aspect of this disclosure, the code compilation module 910 is further configured to compile a network protocol address of the developer tool to obtain a debugging code package.

The code package transmitting module 930 is further configured to transmit the debugging code package to the multi-platform framework, the network protocol address included in the debugging code package being used by the multi-platform framework to establish a network connection to the developer tool.

In this aspect of this disclosure, the code package transmitting module 930 is further configured to encrypt the debugging code package by using a public key of the multi-platform framework, to obtain an encrypted debugging code package.

The code package transmitting module 930 is further configured to sign the encrypted debugging code package by using a private key of the developer tool, to obtain an encrypted and signed debugging code package.

The code package transmitting module 930 is further configured to transmit the encrypted and signed debugging code package to the multi-platform framework.

In this aspect of this disclosure, as shown in FIG. 10, the code package transmitting module 930 includes a file list transmitting unit 931, a configuration information transmitting unit 932, and a compilation result transmitting unit 933.

The file list transmitting unit 931 is configured to transmit a file list of the first application program to the multi-platform framework in response to a file list obtaining request transmitted by the multi-platform framework, the file list recording file information of a compilation result of each code file of the first application program.

The configuration information transmitting unit 932 is configured to transmit configuration information of the first application program to the multi-platform framework in response to a configuration obtaining request transmitted by the multi-platform framework, the configuration information being configured for starting configuration of the first application program.

The compilation result transmitting unit 933 is configured to: in response to a code obtaining request transmitted by the multi-platform framework, transmit a compilation result corresponding to at least one piece of file information included in the file list to the multi-platform framework.

In this aspect of this disclosure, the compilation result transmitting unit 933 is configured to: in a case that a sub-packaging function is enabled, determine file information required for maintaining running of the first application program in the compilation result corresponding to the at least one piece of file information included in the file list as a main package.

The compilation result transmitting unit 933 is further configured to determine file information corresponding to different functions of the first application program in the compilation result corresponding to the at least one piece of file information included in the file list as at least one subpackage, the at least one subpackage corresponding to function description information, and the function description information being configured for describing a function of the first application program corresponding to the subpackage.

The compilation result transmitting unit 933 is further configured to transmit a compilation result of file information corresponding to the main package to the multi-platform framework.

The compilation result transmitting unit 933 is further configured to transmit, in response to a target subpackage obtaining request transmitted by the multi-platform framework, a compilation result of file information corresponding to a target subpackage to the multi-platform framework, the target subpackage being one of the at least one subpackage.

In this aspect of this disclosure, the apparatus includes an indication information transmitting module 940.

The indication information transmitting module 940 is configured to transmit, in response to a request for whether to restart a polling transmitted by the multi-platform framework, restart indication information to the multi-platform framework in a case that the code of the first application program is updated, and start execution from an operation of the compiling a part of code on which update occurs in complete code of the first application program, to obtain a first compilation result.

In this aspect of this disclosure, the first application program is a subprogram, the second application program is a mobile application program, and the first application program and the second application program have a same function.

FIG. 11 is a block diagram of an apparatus for updating and debugging an application program according to another aspect of this disclosure. The apparatus has a function of performing the foregoing method aspects, the function may be implemented by hardware or may be implemented by hardware executing corresponding software. The apparatus may be the computer device described above, or may be disposed in the computer device. As shown in FIG. 11, an apparatus 1100 may include: a code package receiving module 1110 and a program conversion module 1120.

The code package receiving module 1110 is configured to receive an updated code package of a first application program transmitted by a developer tool, the developer tool being configured to write and compile code of the first application program, the updated code package including a first compilation result obtained by compiling a part of code on which update occurs in complete code of the first application program, and a second compilation result stored by the developer tool, and the second compilation result being a compilation result of a part of code on which no update occurs in the complete code; and

the program conversion module 1120 is configured to convert the first application program into a second application program according to the updated code package, running environments of the second application program and the first application program being different.

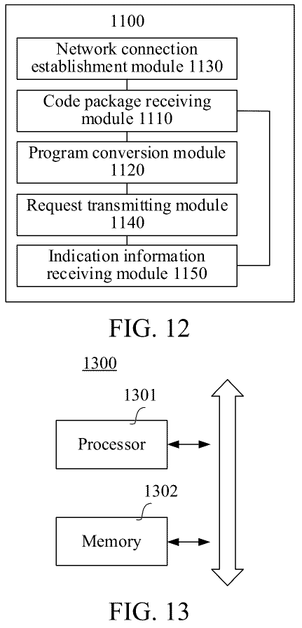

In this aspect of this disclosure, as shown in FIG. 12, the apparatus further includes a network connection establishment module 1130.

The code package receiving module 1110 is configured to receive a debugging code package transmitted by the developer tool, the debugging code package being obtained by the developer tool by compiling a network protocol address of the developer tool.

The network connection establishment module 1130 is configured to establish a network connection to the developer tool based on the network protocol address included in the debugging code package.

In this aspect of this disclosure, the code package receiving module 1110 is further configured to receive an encrypted and signed debugging code package transmitted by the developer tool, the encrypted and signed debugging code package being obtained after the developer tool encrypts and signs the debugging code package.

The code package receiving module 1110 is further configured to perform signature verification on the encrypted and signed debugging code package by using a public key of the developer tool, to obtain an encrypted debugging code package.

The code package receiving module 1110 is further configured to decrypt the encrypted debugging code package by using a private key of the multi-platform framework, to obtain the debugging code package.

In this aspect of this disclosure, the network protocol address includes an Internet Protocol IP address and a port number.

The network connection establishment module 1130 is configured to determine, based on the IP address, a computer device in which the developer tool is located.

The network connection establishment module 1130 is further configured to determine the developer tool from the computer device based on the port number, to establish the network connection.

In this aspect of this disclosure, as shown in FIG. 12, the apparatus further includes a request transmitting module 1140 and an indication information receiving module 1150.

The request transmitting module 1140 is configured to transmit a request for whether to restart a polling to the developer tool, the request for whether to restart a polling being configured for querying the developer tool whether to restart.

The indication information receiving module 1150 is configured to receive restart indication information transmitted by the developer tool, refresh a running result of the second application program, and continue execution from an operation of the receiving an updated code package of a first application program transmitted by a developer tool.

FIG. 13 is a structural block diagram of a computer device according to an aspect of this disclosure.

The computer device 1300 includes a processor 1301 (e.g., processing circuitry) and a memory 1302 (e.g., a non-transitory computer-readable storage medium).

The processor 1301 includes one or more processing cores, for example, a 4-core processor or a 13-core processor. The processor 1301 may be implemented in at least one hardware form of a digital signal processor (DSP), a field programmable gate array (FPGA), or a programmable logic array (PLA). The processor 1301 may also include a main processor and a coprocessor. The main processor is a processor configured to process data in an active state, also referred to as a central processing unit (CPU). The coprocessor is a low-power consumption processor configured to process data in a standby state. In this aspect of this disclosure, the processor 1301 may be integrated with a graphics processing unit (GPU). The GPU is configured to be responsible for rendering and drawing content that needs to be displayed in a display. In some aspects, the processor 1301 may further include an artificial intelligence (AI) processor. The AI processor is configured to process a computing operation related to machine learning.

The memory 1302 may include one or more computer-readable storage media. The computer-readable storage medium may be tangible and non-transient. The memory 1302 may also include a high-speed random access memory (RAM), and a non-volatile memory, for example, one or more disk storage devices and flash storage devices. In this aspect of this disclosure, the non-transient computer-readable storage medium in the memory 1302 stores a computer program, and the computer program is loaded and executed by the processor 1301 to implement the method for updating and debugging an application program provided in the foregoing method aspects.

A person skilled in the art may understand that the structure shown in FIG. 13 does not constitute any limitation on the computer device 1300, and the computer device 1300 may include more components or fewer components than those shown in the figure, or some components may be combined, or a different component deployment may be used.

In an aspect, a computer-readable storage medium is further provided. The storage medium has a computer program stored therein. The computer program, when executed by a processor, implements the foregoing method for updating and debugging an application program.

In some aspects, the computer-readable storage medium may include: a read-only memory (ROM), a random access memory (RAM), a solid state drive (SSD), an optical disc, or the like. The random access memory may include a resistance random access memory (ReRAM) and a dynamic random access memory (DRAM).

In an aspect, a computer program product is further provided. The computer program product includes a computer program. The computer program is stored in a computer-readable storage medium such as a non-transitory computer-readable storage medium. A processor of a computer device reads the computer program from the computer-readable storage medium, and the processor executes the computer program to cause the computer device to perform the foregoing method for updating and debugging an application program.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

What is claimed is:

1. A method for updating and debugging an application program, performed by a developer tool, the method comprising:
compiling a modified portion of a complete code of a first application program to obtain a first compilation result;
generating, by processing circuitry, an updated code package of the first application program based on the first compilation result and a stored second compilation result, the stored second compilation result corresponding to unmodified portions of the complete code; and
transmitting the updated code package to a multi-platform framework, the multi-platform framework being configured to convert the updated code package into a second application program, wherein the second application program and the first application program are configured to operate in different runtime environments.

2. The method according to claim 1, wherein the complete code of the first application program includes at least two code files, each code file including a portion of the complete code, and wherein the compiling the modified portion of the complete code comprises:
identifying at least one target code file from the at least two code files containing the modified portion of the complete code; and
compiling the at least one target code file to obtain the first compilation result.

3. The method according to claim 2, wherein the generating the updated code package comprises:
obtaining the stored second compilation result based on stored compilation results of non-target code files; and
generating the updated code package of the first application program based on the first compilation result and the stored second compilation result.

4. The method according to claim 2, further comprising:
deleting stored compilation results corresponding to the at least one target code file; and
storing the updated compilation result corresponding to the at least one target code file.

5. The method according to claim 1, further comprising:
compiling a network protocol address of the developer tool to obtain a debugging code package; and
transmitting the debugging code package to the multi-platform framework, the debugging code package including the network protocol address for establishing a network connection to the developer tool.

6. The method according to claim 5, wherein the transmitting the debugging code package comprises:
encrypting the debugging code package using a public key of the multi-platform framework, to obtain an encrypted debugging code package;
signing the encrypted debugging code package using a private key of the developer tool to obtain an encrypted and signed debugging code package; and
transmitting the encrypted and signed debugging code package to the multi-platform framework.

7. The method according to claim 1, wherein the transmitting the updated code package to the multi-platform framework comprises:
transmitting a file list of the first application program to the multi-platform framework when a file list obtaining request is transmitted by the multi-platform framework, the file list recording file information for each code file of the first application program;
transmitting configuration information of the first application program to the multi-platform framework when a configuration obtaining request is transmitted by the multi-platform framework, a configuration of the first application program being initiated based on the configuration information; and
when a code obtaining request is transmitted by the multi-platform framework, transmitting at least one compilation result corresponding to at least one code file listed in the file list.

8. The method according to claim 7, wherein the transmitting the at least one compilation result comprises:
when sub-packaging is enabled, determining a first portion of the complete code required for maintaining operation of the first application program as a main package;
determining a second portion of the complete code corresponding to different functions of the first application program as at least one subpackage, each of the at least one subpackage corresponding to function description information, and the function description information describing a function of the first application program corresponding to the subpackage;
transmitting a compilation result of the file information corresponding to the main package; and
transmitting, in response to a subpackage obtaining request, a compilation result of the file information corresponding to a requested subpackage.

9. The method according to claim 1, further comprising:
receiving, from the multi-platform framework, a polling request inquiring whether to restart; and
transmitting, when the polling request is received, restart indication information to the multi-platform framework when the modified portion of the complete code of the first application program is modified to trigger recompilation.

10. The method according to claim 1, wherein the first application program is a subprogram, and the second application program is a mobile application program, the first application program and the second application program having a same function.

11. A method for updating and debugging an application program, performed by a multi-platform framework, the method comprising:
receiving, from a developer tool, an updated code package of a first application program, the updated code package including a first compilation result of a modified portion of a complete code of the first application program and a stored second compilation result of unmodified portions of the complete code; and
converting the first application program into a second application program based on the updated code package, wherein the second application program and the first application program are configured to operate in different running environments.

12. The method according to claim 11, further comprising:
receiving a debugging code package from the developer tool including a network protocol address; and
establishing a network connection to the developer tool based on the network protocol address included in the debugging code package.

13. The method according to claim 12, wherein the receiving the debugging code package comprises:
receiving an encrypted and signed debugging code package from the developer tool;
verifying, using a public key from the developer tool, the encrypted and signed debugging code package to obtain an encrypted debugging code package; and
decrypting the encrypted debugging code package using a private key of the multi-platform framework, to obtain the debugging code package.

14. The method according to claim 12, wherein the network protocol address includes an Internet Protocol (IP) address and a port number; and
the establishing the network connection comprises:
determining a computer device corresponding to the IP address; and
determining the developer tool from the computer device based on the port number, to establish the network connection.

15. The method according to claim 11, further comprising:
transmitting a polling request inquiring whether to restart the developer tool;
receiving restart indication information from the developer tool;
refreshing running results of the second application program; and
receiving another updated code package from the developer tool.

16. An apparatus, comprising:
processing circuitry configured to:
compile a modified portion of a complete code of a first application program to obtain a first compilation result;
generate an updated code package of the first application program based on the first compilation result and a stored second compilation result, the stored second compilation result corresponding to unmodified portions of the complete code; and
transmit the updated code package to a multi-platform framework, the multi-platform framework being configured to convert the updated code package into a second application program, wherein the second application program and the first application program are configured to operate in different runtime environments.

17. The apparatus according to claim 16, wherein the complete code of the first application program includes at least two code files, each code file including a portion of the complete code, and wherein the processing circuitry configured to:
identify at least one target code file from the at least two code files containing the modified portion of the complete code; and
compile the at least one target code file to obtain the first compilation result.

18. The apparatus according to claim 17, wherein the processing circuitry is configured to:
obtain the stored second compilation result based on stored compilation results of non-target code files; and
generate the updated code package of the first application program based on the first compilation result and the stored second compilation result.

19. The apparatus according to claim 17, wherein the processing circuitry is configured to:
delete stored compilation results corresponding to the at least one target code file; and
store the updated compilation result corresponding to the at least one target code file.

20. The apparatus according to claim 16, wherein the processing circuitry is configured to:
compile a network protocol address of a developer tool to obtain a debugging code package; and
transmit the debugging code package to the multi-platform framework, the debugging code package including the network protocol address for establishing a network connection to the developer tool.
